(19) United States
(12) Patent Application Publication
(10) Pub. No.: US 2006/0078660 A1
(43) Pub. Date: Apr. 13, 2006

(54) Ready to bake layered dough product and methods

(76) Inventor: Merrie Martin, Chagrin Falls, OH (US)

Correspondence Address: WINSTON & STRAWN LLP, 1700 K STREET, N.W., WASHINGTON, DC, 20006, US

(21) Appl. No.: 11/288,374

(22) Filed: Nov. 29, 2005

Related U.S. Application Data
(63) Continuation-in-part of application No. 10/695,835, filed on Oct. 30, 2003.
Application No. 10/695,835 is a continuation of application No. PCT/EP02/04503, filed on Apr. 23, 2002.
(60) Provisional application No. 60/287,393, filed on Apr. 30, 2001.

(51) Int. Cl. A21D 6/00

(52) U.S. Cl. 426/496

(57) ABSTRACT

The invention relates to a ready-for-use bakery dough product which can be preserved in the refrigerator and which is prepared from flour, sugar, egg, starch, emulsifiers, baking powder, water and fat, and provided in a bar or block form. This bakery dough is placed in a baking tin and then baked to form individual baked products. In addition, the block can be formed of different dough layers or strips, or each portion can be provided with a different color, decoration or filling. Different doughs can be swirled together to provide a marbled appearance in the block or in the layers or strips. The dough and resulting bakery product can be filled.

### CROSS REFERENCE TO RELATED APPLICATIONS

This application is a continuation-in-part of U.S. application Ser. No. 10/695,835, filed Oct. 30, 2003, now pending, which is a continuation of international application no. PCT/EP02/04503 filed Apr. 23, 2002, and claims the benefit of U.S. provisional application no. 60/287,393 filed Apr. 30, 2001, the entire contents of each of which are expressly incorporated herein by reference thereto.

### FIELD OF THE INVENTION

The invention relates to a ready-for-use packaged dough product, and methods of making and using the same, which can be preserved in the refrigerator and which is prepared from one or more of flour, sugar, water, egg, emulsifier, starch, baking powder and fat. When the product is to be prepared, the dough product is simply removed from the package, placed in a pan and baked in an oven. The simplicity of the product enables freshly baked dough product, such as a brownie bar, to be made easily and rapidly.

### BACKGROUND OF THE INVENTION

Bakery products such as brownie products are generally provided as dry mixes to which eggs, oil and water and other ingredients such as nuts or chocolate pieces are added, the product is appropriately mixed and then placed in a pan for baking. Furthermore, with these dry mixes, the consumer has to prepare the bakery dough, which takes time and necessitates the use of different types of kitchen utensils.

PCT WO 01/06858 discloses a brownie dough that is provided as a sheet with score lines defining pieces of dough that were broken off, placed in a baking pan in spaced relation and then baked into brownies. The spaces between the dough enabled the heat to flow around the pieces to provide more uniform baking. Also, the mix could flow into the spaces between the pieces to form the final baked product. The breaking and placement of the pieces takes some time and care by the consumer in order to properly obtain the final product.

A refrigerated brownie batter contained in a pan is commercially available. Having the batter contained in a pan prior to baking is the ultimate in consumer convenience; however, it lacks consumer involvement and creates environmental waste, and inconvenient storage because of the excess packaging.

Accordingly, there is a need for improved brownie dough products that avoid excess packaging and that are easy and convenient for the consumer to use. The present invention now resolves this need.

### SUMMARY OF THE INVENTION

The present invention encompasses a ready-to-bake dough bar having edges, a top, and a bottom in a pre-defined shape including a first dough portion having a first texture and that forms a base layer, wherein the first dough is sufficiently viscous to retain its pre-defined shape under ambient temperature before baking while being transferred from a sealed storage package to a baking container having a shape, yet is sufficiently fluid to flow at baking temperatures to conform to the shape of the baking container, and a second dough portion having a second, different texture that forms a second layer disposed over a portion of the base layer and that is retained in the bar to minimize or avoid burning or scorching of the second dough portion during baking, wherein the dough portions are associated with each other for simultaneous baking and together form a parallelepiped-shaped bar that is the ready-to-bake dough bar, and wherein the second dough portion is hidden from view along the bar edges until an internal portion of the ready-to-bake dough bar is separated from the remainder of the bar along a separation zone oriented from the top to the bottom of the bar.

The dough product can be coextruded in a sheet or block form that has a substantially uniform thickness. Although not required, the top or bottom can include an imprint of grooves, score lines, or combinations thereof, that defines pieces of the dough to be broken off before being baked or to suggest portion sizes, with the imprint extending into the thickness of the dough. In preferred embodiments, there are no grooves or score lines on the dough that define pieces to be broken off. In one embodiment, the bar has a thickness and a surface that includes grooves, score lines, or combinations thereof, that define pieces of the dough to be broken off, wherein the grooves, score lines, or combinations thereof each have a depth of about 3% to about 95% of the thickness of the bar. In another embodiment, the first dough portion surrounds the second dough portion. A preferred embodiment of this is where the first dough portion entirely surrounds the second dough portion so as to further form an upper layer of the dough bar.

In another embodiment, the dough bar further includes a third dough portion disposed over a portion of the second layer so that the first, second, and third dough portions together form the ready-to-bake bar. In a preferred embodiment, the third dough portion has a third texture that is different from the second texture of the second dough portion. In one preferred embodiment, the third dough portion entirely surrounds the second dough portion and the first and third dough portions form the entire outer surface of the dough bar. In yet another preferred embodiment, the dough bar includes four layers, i.e., the three noted above and a fourth dough layer disposed over a portion of the third layer so as to further form an upper layer of the dough bar.

It is also preferred that the dough bar further include a plurality of dough portions disposed over a portion of the base layer, over a portion of the second layer, or both so that the first, second, and plurality of dough portions together form the ready-to-bake bar.

One preferred embodiment is wherein the first and second dough portions each have a different flavor and color. Preferably, the first and second dough portions are sufficiently viscous to inhibit or avoid miscibility thereof, preferably even at about 185° F.

The invention further encompasses ready-to-bake dough bar products that are formed from the ready-to-bake dough bar above, a substrate that supports the dough bar during shipping to minimize modification of its shape, and a package or enclosure that contains, protects, and seals the dough bar therein until it is opened. Further, the invention relates to a separated baked dough bar that includes a separated portion of the baked ready-to-bake dough bar having at least two layers visible at the separation zone.

The invention also encompasses methods of providing a dough product having a top, a bottom, and edges, that includes providing first and second dough portions that are formulated to differ in texture and appearance after the dough product is baked, associating the dough portions together with the first dough forming a base layer and the second dough disposed over a portion of the base layer to form a ready-to-bake parallelepiped-shaped dough product so that the second dough portion is hidden from view along the bar edges, transporting the dough product to a remote location in a sealed package, and providing instructions which include: removing the ready-to-bake dough product from the package; directly placing the product in a baking container without modifying its shape; and baking the ready-to-bake dough product.

In one embodiment, the dough product obtained after baking has at least two portions that become visible when a portion of the dough product is separated from a second portion of the dough product along a top to bottom interface, wherein the at least two portions each has a different texture and a different appearance.

The invention also encompasses methods for making a fresh baked dough bar product by formulating a first dough that is sufficiently fluid to flow yet sufficiently viscous to retain a second dough at a baking temperature, formulating the second dough and disposing it over a portion of the first dough so as to be retained thereby, and providing the doughs in the form of a bar having at least two layers to form a multi-layer structure in a sealed package, the bar having sufficient firmness to be handled without breaking or being altered in overall shape when transferred from the package to a baking container, wherein when fresh baked dough bars are desired, a consumer removes the dough bar from the package, places it in the baking container and places the container and bar into an oven heated to the baking temperature for a sufficient time to prepare a baked dough bar product that is not collapsed in the center of the container after baking, and wherein, when one or more portions of the baked dough bars are separated along a top to a bottom interface from the remainder, the multi-layer structure of the bar becomes visible to the consumer. In one embodiment, the dough bar includes a brownie bar or a cookie bar, or a combination thereof.

In one embodiment, the baking container is sized and dimensioned to provide a margin of about 1 cm to 6 cm between each side wall of the container and the edges of the dough bar, and wherein the dough on each edge flows to a position adjacent the margin of, or contacting, the container during baking.

The new dough product is time saving, necessitates no need to arrange dough pieces in a pan or spread batter in a pan and guarantees a consistent quality of the final baked brownies. Furthermore, the dough has a light leavened appearance and does not have a collapsed texture after baking.

During baking, the dough typically flows to fill the bottom of the pan. The pan, or baking container, is provided by the consumer and the dough typically flows to fill the pan.

In an alternative, it is also possible to portion the bar and bake every piece on a cookie tray or form to give a plurality of individual items/cookies/dough bars after baking.

In addition, if desired, the pieces of the dough product can be provided with different colors, different textures, specific figures, or decorations thereon or with fillings therein to enable the consumer to prepare these variations of the final products from the single bakery dough block.

### BRIEF DESCRIPTION OF THE DRAWINGS

Preferred embodiments of the invention, specifically in the form of a block of bakery dough, can be observed by reviewing the following detailed description and appended drawing figures, wherein:

FIG. 1 is a perspective view of a bakery dough bar or block in accordance with a first embodiment of the invention;

FIG. 2 is a perspective view of a separated portion of a bakery dough block in accordance with another embodiment of the invention where two different layers of dough are laminated together;

FIG. 3 is a cross-sectional view of a dough bar including two dough layers and a filling layer according to an embodiment of the invention;

FIG. 4 is a cross-sectional view of a dough bar having four layers placed vertically adjacent to each other;

FIG. 5 is a cross-sectional view of a dough bar of the invention that has a discontinuous filling layer inside;

FIG. 6 is a cross-sectional view of a dough bar of the invention that has a continuous filling layer between a base dough layer and a second dough layer with a surface decoration disposed thereover; and

FIG. 7 is a cross-sectional view of a dough bar of the invention that has a continuous filling layer inside by being disposed over a base dough layer and having a second dough layer disposed thereabout.

### DETAILED DESCRIPTION OF PREFERRED EMBODIMENTS

It has now been discovered that ready-to-bake dough bars with at least two different dough portions having two different textures, with one forming a base and the other disposed and retained thereon to minimize or prevent scorching or charring thereof during baking, can now be provided with minimal consumer effort. A consumer can now simply remove a dough bar of the invention from a package, stick it directly in a baking tray using their hands or a tool, but without any further shaping required, turn on the oven and time the cooking, and then remove separate pieces and serve. Advantageously, the first and second dough portions have different textures and are preferably visually distinct, but this preferably cannot be seen by the consumer until after baking when the pieces are separated. The dough bars of the invention are not simply aesthetic, but additionally through use of a second dough that is less viscous than the first, and optionally a filling that is sufficiently viscous and/or retained by a more viscous base dough, for example, the product can more readily flow to fill a baking container during cooking while minimizing oozing of a filling or second dough that tends to cause burning or scorching thereof.

The present invention relates to a new form of pre-mixed or pre-prepared bakery dough products that are ready for baking. The term “bakery dough” is used to mean pre-mixed doughs of the types used for making bakery items where the dough is provided in the form of a sufficiently solid or semi-solid block that is typically provided under refrigerated or frozen conditions and which is then placed into a baking tin for baking. In one embodiment the dough is refrigerated to expedite baking, while in another it is frozen to minimize spoilage or deformation during transport to the end-user. The dough bars can be frozen when the end-user receives them, then refrigerated prior to baking.

The invention encompasses including a base layer and from one to preferably no more than five other dough layers disposed thereon. The base layer (also called the first layer) of the dough bar is formed of a first dough, while a second layer of a second dough that is visually distinct from the first dough is disposed over a portion of the base layer. The other layers can have one of the first two types of dough or different dough compositions so long as alternating layers are visually distinct (at a minimum) or every layer is visually distinct, but there are at least two types of dough in at least two of the layers. Additional layers of visually distinct doughs, or fillings or topping layers, can be disposed thereon or therebetween in other embodiments. A preferred dough bar includes four layers including the base layer, and in one embodiment the layer appearance alternates, e.g., in an “ABAB” format. The invention also encompasses every other variety of visual differences in the layers, including ABCD, ABAC, ABAD, ABCA, etc. A filling or topping layer may take the place of any dough layer except the base dough layer, or may be disposed between (a filling) two dough layers or over (topping) other dough layer(s).

Preferably, when a second dough layer is adjacent the first layer, a third dough layer can be disposed over and around an exposed portion of the second dough layer. This additional third dough layer retains the second dough layer adjacent the first layer and minimizes oozing of the second dough layer onto the hot surfaces of the baking container. The second dough layer is sufficiently flowable to spread towards the baking container as the first layer expands, but sufficiently viscous that the second layer will not flow out of or off of the base layer even after the bar is separated along an internal separation zone. The internal separation zone is, e.g., an internal cross-section of the dough bar that extends from the top to the bottom of the dough bar. When a vertical cross-section of the dough bar is viewed from the side, the visually distinct dough layers will be visible. Moreover, the second dough layer is sufficiently viscous that it provides a structure that prevents collapse of a central portion of the dough bar even after baking the dough bar. This arrangement of third layer around at least the sides and a portion of the top of the second layer prevents edgewise viewing of the visibly distinct layers until after the dough bar is baked and portions separated therefrom along one or more separation zones. In this embodiment, e.g., pinpoint-sized holes can be included in the third dough layer to permit escape of moisture from the second dough layer during baking. Preferably, the third layer entirely encloses the sides and upper surfaces of the second layer not in contact with the first layer, so that the first and third layers together surround the second layer. In a preferred embodiment, the second dough layer is a filling. The separation zones are preferably along any cut from the top to the bottom of the dough bar that separates a portion thereof along an internal line across the dough bar.

The bakery dough most preferably includes or is a brownie dough or cookie dough, or both, but also may be a cake dough, a muffin dough, or any other dough product which can be baked in an oven, in a baking tin or in individual forms or cups or on a baking sheet. For instance, the individual forms can be made of baking paper or aluminum foil or can be molds in a tray (i.e., a muffin pan).

The bakery dough product according to the invention can be provided in any form but the bar or block form is particularly advantageous. This block may be either of parallelepipedal form, or of cylindrical form, or of prismatic form, or it can have any one of a variety of other shapes. While rectangular or square peripheries are preferred, the bar or block may have a periphery that is round, oval, or that corresponds to a triangle or other polygon. The shape of the bar is advantageously selected to conform to the shape of the pan in which the dough bar is to be baked.

The most advantageous configuration for the bar is one that is slightly smaller in periphery than the pan in which is it to be baked. For example, a margin of about 1 cm to 6 cm between the dough and the pan wall or walls is advantageous, with smaller margins resulting in thicker brownies and larger margins resulting in thinner brownies. If margins are not provided and the dough bar has essentially the same dimensions as the pan wall or walls, the edges of the brownie dough bar will be cooked to a harder consistency than if spaced margins are provided. This is not necessarily a disadvantage, as some consumers prefer harder crust on baked products. For the softest edges, however, a margin or space should be provided between the edges of the dough bar and the wall or walls of the pan so that the dough can flow to the pan walls during baking, rather than being in contact throughout the entire time of baking.

Although any suitable size or type baking container can be used, preferred are conventional baking pans are rectangular with a length of about 33 to 40 cm, a width of about 23 to 30 cm, and sidewalls that are about 6 cm in height. Thus, dough bars that are rectangular with a length of about 20 to 35 cm, a width of about 10 to 25 cm and a thickness of about 2 to 4 cm are preferred for use with such conventional pans. One of ordinary skill in the art can easily select the preferred size of the bar based on the pan size in which it is to be baked. The formulation of the dough is such that it is sufficiently fluid to fill in the open areas of the margin so that the dough fills the entire bottom of the pan during baking.

The dough of the present invention can be stored under frozen or refrigeration temperatures, e.g., in a conventional refrigerator, at temperature preferably from about 2° C. to 10° C., preferably about 3° C. to 7° C. When fresh baked products are desired, the consumer simply removes the package from the refrigerator, takes the dough bar out of the package and places it into a pan, and then places the pan and dough bar into the oven for baking. For longer-term storage of the product, the packaged dough bar may be frozen although this is not required. When a baked product is to be prepared, the package is simply removed from the freezer and thawed at least to refrigeration temperatures prior to baking. This can be done by placing the frozen package into the refrigerator for a sufficient time for it to warm to refrigeration temperatures, or by removing it from the freezer and placing it on a counter or table until it warms. While not detrimental to the product, it is not necessary to warm the dough bar to room temperature prior to baking.

As noted above, the only manipulation by the consumer is the placement of the dough into the prepared pan, prior to baking. The dough bar can be placed even without use of a tool or cooking implement, i.e., the sealed package is opened, and the dough bar is removed and placed directly into a baking container, whereupon it is baked. There is thus no waste due to forming the bar into a desired shape. The dough bar is sufficiently rigid, or non-deformable, to retain its shape before being baked.

In one embodiment, the dough block has an imprint to facilitate breaking the dough into smaller blocks, pieces or portions before being baked. The block of dough with an imprint can be broken into smaller blocks by using any suitable tool, such as a knife, or by hand. When using a knife, the knife completely cuts the block of dough beyond the imprint. Alternatively, the block of dough can be pulled apart using one's hands. As long as the block of dough has an imprint or a partial cut, the dough blocks can be either cut or broken into smaller size pieces of rectangular, circular, triangular or any other geometric shapes. There is no waste due to shaping and no manipulation, other than cutting or breaking of the dough bar after being baked to expose the visually distinct layers therein. Preferably, however, there is no manipulation of any kind, e.g., by hand or tool, between the opening of the package and placement of the ready-to-bake dough bar into the baking container.

The dough typically includes a leavening agent. Any conventional leavening agent can be utilized depending upon the final product and its desired characteristics. One common leavening agent is baking powder, and this is advantageous for preparing dough which flows when baked. This agent at least in part contributes to the ability of the dough pieces to flow into a round bakery product, such as a cookie, during baking.

As used herein, “baking powder” means a mixture of at least one bicarbonate or carbonate salt, at least one acidifying agent and at least one separating agent. These ingredients and adequate substitutes are commonly known to those of ordinary skill in the art, therefore, any known ingredient or substitute can be used with the invention. A carbonate compound, such as sodium bicarbonate, may be used alone, or is preferably used with sodium diphosphate or disodium dihydrogen pyrophosphate with a starch as separating agent. These mixtures are directly available commercially with a fixed composition. Other, similar agents can be used if desired. An exemplary mixture of baking powder can include bicarbonate in an amount of about 30%, acid in an amount of about 40%, and a separating agent in an amount of about 30% by weight. In a specific embodiment, sodium bicarbonate may be used alone in an amount of about 0.1% to 2% by weight, preferably about 0.2% to 0.7%, and more preferably about 0.5% by weight.

Other conventional leavening agents can be used, including phosphates such as disodium dihydrogen pyrophosphate. These agents are typically used in an amount of about 0.1% to 3% by weight. The amount and type of leavening agent can be selected to permit the second dough portion from oozing out or escaping the first dough portion that retains it to minimize or prevent scorching of the second dough during baking. For certain dough bar products, the leavening agent may be omitted.

Any type of flour can be used, preferably from any cereal. Typically, the flour can be a cereal flour with a high or low protein content. The flour content of the bakery dough is normally from about 5% to about 60%, preferably from about 10% to about 40% and more preferably from about 27% to about 37% by weight. In one embodiment, the flour is present in an amount of about 5% to 20%. It is the starch component of the flour that hydrates and allows formation of a dough.

The sugar that is used can be of any type. Sugars include, but are not limited to, fructose, sucrose, dextrose, corn syrup, glucose, lactose, galactose, or mixtures thereof. Preferably, sucrose is used, in granulated or powdered form. To increase dough sweetness, a sugar substitute such as sorbitol, saccharine or any other known sugar substitute including saccharine, aspartame, SPLENDA® or the like, or a combination thereof, can be added either in conjunction with sugar or as a substitute for the sugar. Advantageously, sucrose helps preserve the dough during refrigeration, i.e., sucrose allows the dough to be somewhat hard, yet spread well during baking to form the desired shape. Other sugar substitutes or artificial, i.e., non-nutritive sweeteners, can be used when low calorie baking products are to be made. In a preferred embodiment, the bakery dough includes at least 0.5% by weight of an artificial or natural sweetener. The sugar or sugar substitute can be present in an amount from about 5% to about 50%, and preferably in an amount from about 10% to about 40% by weight. An exemplary amount of sweetener is from about 30% to 50%. The resulting dough bar should have a good resistance during preservation in the refrigerator or freezer, that is to say that it should be quite firm, but should nevertheless spread sufficiently during baking. The sugar preferably includes sucrose.

The dough bar should have a moisture content from about 2 to about 25%, preferably from about 8% to about 22%, and more preferably about 12% to 16% by weight before baking, although this will decrease upon baking. In one exemplary embodiment, the moisture content is about 13% to 23%.

The type of fat has an influence on the flow capacity of the dough during baking. The fat used in the dough composition according to the invention can be a solid or liquid fat at room temperature. The fat can be of animal or plant origin, such as, lard, tallow, butter oil, butter, margarine, corn oil, copra oil, palm oil, sunflower oil, safflower oil, canola oil, soya bean oil, coconut oil, palm kernel oil, cotton oil, peanut oil, olive oil, or mixtures thereof. The fats can be emulsified or stabilized with mono- or diglycerides or other emulsifiers known in the art. For example, margarine, which already contains an emulsifier, can be used. Typically, a fat is present in an amount from about 5% to about 35%, and preferably in an amount from about 10% to about 25% by weight. The solids content of fat used has an influence on the flow capacity of the dough during baking. When solid fat content of the fat increases to 50% by weight at 10° C., dough handling is improved, but dough flow is diminished and baked product texture tends to be more dry and hard compared to a lower solid fat content.

It should be understood that the type and amount of fat are selected to permit the first dough portion to retain the second dough portion and minimize the scorching, charring, or burning thereof should the second dough contact the baking surface. Preferably, the second dough portion is sufficiently flowable or expandable to expand along with the first dough portion, which first dough portion expands to contact various internal surfaces of the baking container. The second dough portion, however, is sufficiently viscous or expandable that it does not flow out or off of the first dough portion even after baking and separating of portions of the bakery dough bar at one or more separation zones. Therefore, in a preferred embodiment, even at baking temperatures the second dough portion will not ooze or overflow the base layer disposed thereunder.

Optionally, a texturing agent can be included in an amount of up to about 20%. One of ordinary skill in the art can determine the appropriate texturing agent with little or no experimentation. A preferred texturing agent is whole egg or egg white, liquid or dried egg powder or any egg substitute. Typically, the texturing agent can be in an amount from about 0.1% to about 10%, and preferably in an amount from about 2% to about 5% by weight. An exemplary amount of texturing agent includes an amount of about 9% to 15%. This component can contribute structure to the baked product and the emulsifier present in egg contributes to good dough handling properties. Emulsifiers at an amount of about 0. 1% to 2%, and preferably from about 0.3% to 0.75% are also present. The type of emulsifier is not critical and can be from any approved sources for use in bakery products.

The bakery dough according to the invention may also contain natural or artificial flavoring agents, including but not limited to, vanilla flavor, cinnamon, ginger, cocoa powder, fruit flavor, nut flavor (e.g., peanut butter or peanut flour), sandwich cream filling, and the like. These are typically used in an amount of about 0.01% to about 8% by weight, and preferably from 0.25 to 7% by weight. Of course, various combinations of these flavoring agents are possible, as desired. The dough may or may not contain chocolate, however, it preferably includes cocoa powder, chocolate, or both. For example, the dough can be chocolate chip dough, chocolate chunk dough, peanut butter dough, chocolate dough, brownie dough with nuts, etc.

Optionally, the dough may contain inclusions. These are distributed in the dough bar, preferably substantially or entirely uniformly. Inclusions include, but are not limited to, chocolate pieces, oat flake pieces, raisins, fruit pieces, whole nuts or nut pieces, i.e., groundnuts, hazelnuts or other nuts, caramel, sugar pieces, or various mixtures thereof. The inclusions can be of any edible size, and are typically from about 1 mm to about 25 mm, preferably from about 4 mm to about 10 mm. The amount of inclusions is not critical and can vary from about 0. 1% to 30% by weight. Optionally, dark chocolate, milk chocolate, white chocolate, compound coatings or mixtures thereof may be used in the form of morsels, pellets or chunks. Typically, when used as an inclusion, chocolate can be present in an amount from about 5% to about 50%, and preferably in an amount from about 10% to about 30% by weight. The chocolate can be a commercial chocolate or a chocolate of the type used in pastry making or in catering.

In the present description, the components are given in percent by weight of the dough. None of the constituents of this mixture is critical. In one exemplary embodiment, the dough can be formulated with sugar, flour, a starch, a fat, an emulsifier and water, with the fat having a solid fat index at 10° .C of above 31 but below 50, and with less than 3% by weight of cold swelling starch based on the weight of the dough. Preferably, the sugar is present in an amount of about 25% to 55% by weight, the flour is present in an amount of about 3% to 25% by weight, the fat is present in an amount of about 10% to 30% by weight, the starch is present in an amount of about 1% to 20% by weight, the emulsifier is present in an amount of about 0.1 to 2%, the water is present in an amount of about 10% to 25% by weight, egg, egg white or an egg substitute is present in an amount of up to about 20%, and a baking powder or sodium bicarbonate in an amount of up to 2%, each percent based on the weight of the dough.

The bakery dough bar can be made into parallelepipedal pieces of about 8 cm to 20 cm, preferably about 11 cm to 14 cm in width and length size, which can be independently selected, and about 0.5 to 6 cm, preferably about 1 cm to 5 cm thick. An exemplary thickness is from about 2 cm to 4 cm. The width and length dimensions are not critical so long as the bakery bar is sized and dimensioned to fit a baking container, preferably with a margin as described herein. The block can be in any shape or of any circumference, but preferably is rectangular or square to correspond to most conventional brownie or cake baking containers.

The entire block may be baked in a pan of as much as substantially double the size: for the example of a rectangle dough bar of about 11×14 cm, it is possible to use a square pan of about 20×20 cm. The block is placed in a baking pan so that at the end of the baking, the dough has flowed to fill the pan due to the flowability of the dough and the center dough layer(s) of the brownie is or are aerated in texture due to the protein/starch/emulsifier structure formed during baking. Alternatively, the dough may be unleavened to provide a fudge-like texture that is dense or a cookie-bar texture that is not as dense as fudge but may be more dense than a brownie-bar particularly if the cookie-bar includes chocolate inclusions.

After the block is placed in the pan, it is ready for baking under conventional conditions, e.g., at a temperature of about 160° C. to 185° C. for a time of about 10 minutes to 75 minutes to prepare the baked dough bar product. An exemplary cooking instruction is at a temperature of about 175° C. for 20 to 60 minutes. After baking, the final product is cooked correctly and can be eaten. It is preferred that the bar is separated into smaller portions along one or more internal separation zones of the baked product to form individual servings so that the internal striation of layers becomes visible. The invention also includes instructions to remove the bar from the package, place in a baking container, cook under the above-noted conditions, and separate into smaller portions to as to expose the visual distinctions along the internal separation zone(s) of the dough bar.

It should be understood that the internal layers are not visible until a portion of the dough bar is separated or cut away from the rest, and that only the base dough, toppings, and any optional but preferred side-coating materials are visible to keep the internal layer structure hidden from view until baked and ready to eat. The optional side-coating material(s) can be used if the base dough layer is not extended upwardly to help retain the other layers of dough or fillings, and these side-coating materials can simply be those of any dough layer described herein.

When first prepared for storage or shipping to end-users, the block of dough is wrapped conventionally, for example, in a plastic or other synthetic material or a covered carton, so as to be sealed and protected from air and moisture prior to use, i.e., placement and baking. The shelf life of the dough according to the invention in a refrigerator is normally on the order of several months, preferably at least about 6 months, and more preferably at least about 9 months.

In one exemplary embodiment, the invention relates to a method for making a fresh baked product which includes formulating a dough that is sufficiently fluid to flow at baking temperatures but sufficiently viscous so that a central dough portion is retained by the first dough portion that forms the base layer even at 170° C.; and providing the dough in the form of a bar in a sealed package. This bar has sufficient firmness to be handled without breaking such that, when fresh baked dough bars are desired, a consumer simply removes the dough bar from the package, places it in a baking pan and places the pan and bar into an oven heated to a baking temperature for a sufficient time to prepare a baked product that is not collapsed in the center of the pan after baking. The dough may be formulated in the shape of a round, oval or polygonal bar having a thickness of about 1 and 5 cm prior to packaging. Preferably, the dough bar is configured in the shape of a rectangular bar having a length of about 15 to 40 cm and a width of about 10 to 25 cm and is packaged in sealed plastic material. To bake the product, only the following steps are conducted by the consumer: the dough bar is removed from the package and is placed in a pan, the pan and dough bar are placed in an oven that is heated to a temperature of about 160 to 185° C. for a time of about 10 to 75 minutes to prepare a baked product, and the product can be cut or separated along internal separation zones into smaller portions for serving and/or eating.

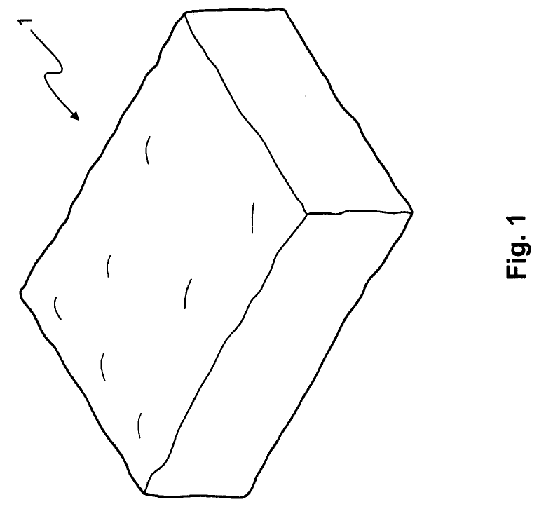

A typical block of bakery dough according to the invention is shown in FIG. 1. The block 1 of bakery dough can be prepared with the composition stated in Example 1. The preparation is made conventionally and is formed into a rectangular bar of desired thickness.

The invention also relates to a ready-for-use bakery dough product in the form of a block which exhibits at least two different dough layers that are visually distinct, and optionally, one or more decorations on the top of the block. The dough bar of FIG. 1 can thus include a continuous or discontinuous dough layer (not shown) disposed entirely within the first dough, and this dough layer is preferably a filling.

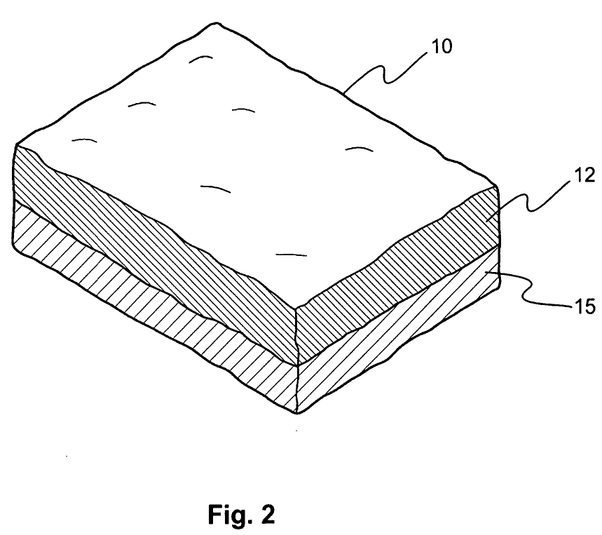

According to one embodiment of the invention, as shown in FIG. 2, a portion of the block 10 is separated from the rest of the block (not shown) along each of the four sides each at an internal separation zone, and has at least two different adjacent layers 12, 15 that are visually distinct from each other. The block 10 of bakery dough is prepared with a suitable composition, such as that stated in Example 2. The preparation is made by conventional means. The block is formed with two layers: a top layer 12 made with a classical dough and a lower layer 15 made with the same dough but with the addition of cocoa such as is commonly used to make conventional bakery items.

The number of additional optional layers included over the base layer 15 and second layer 12 is not critical, but from a practical point of view, this number of layers is typically from 2 to 6. Preferably, the number of layers is 2 to 5, more preferably 3 to 4 in one embodiment. At least two, preferably three, and more preferably all of the layers present are visually distinct from each other, and can be the same material but are preferably a different texture, different tasting composition, or both, in addition to being visually distinct. Each layer is preferably visually distinct from one and more preferably two adjacent layers (if a second adjacent layer is present). This can be done, for example, by adding to the basic dough different types of flavors or colors, which are accepted in the food area, or by formulating different dough portions. For example, it is possible to have a basic dough as first layer and dough which has cocoa as the second layer, wherein the resulting cake has both a clear or light face and a dark face. When the second layer is surrounded by the first dough, or first dough and an optional third dough, the color and flavor of the internal second layer will be a surprise to the consumer who can discover this upon separating smaller portions from the block along an internal separation zone. The separation zone is preferably from the top to the bottom of an internal portion of the block along a sufficient horizontal distance to separate a portion of the dough bar from the remainder. The way for producing this layered dough can be either by extrusion, sheeting, lamination or by other ways which are known or available in the art. For instance, a creamy layer can be interposed between two non-creamy layers or a creamy layer can be positioned at the bottom or top of the block. In fact, the invention contemplates a wide range of layers having different characteristics, composition, texture, taste, shapes and/or colors.

Preferably, there are four to six layers in the dough bar, and at least three to six of the layers have a different flavor and color compared to the layers vertically adjacent to each. More preferably, each of the layers in the dough bar has a different color, flavor, and texture from at least the vertically adjacent layers. In one embodiment, each layer has a different color, flavor, and texture from all other layers. These texture and composition differences between vertically adjacent layers can advantageously permit the dough bar to better retain its structure by minimizing or preventing any materials from escaping the dough bar structure, e.g., through the use of sufficiently viscous dough, inclusion, filling, or topping materials.

A few exemplary dough arrangements, with the general pattern of base dough, filling, second dough layer, and topping, from bottom (base layer) to the top according to the invention include the following. A chocolate-nut dough bar can include chocolate chip dough, chocolate filling, chocolate dough substantially or entirely free of inclusions, and chopped nuts, such as pecans (an ABCD configuration). A peanut-butter chocolate bar can include chocolate dough, peanut butter filling, chocolate dough, and peanut butter morsels (an ABAC configuration). Another type of exemplary bar includes a nut-based chocolate bar of oatmeal chocolate chip base dough, peanut butter filling, chocolate dough, and chopped nuts, such as pecans or walnuts (ABCD). Yet another bar includes a white chocolate chip dough base, raspberry filling, white chocolate chip dough, and white chocolate morsels (ABAC). A chocolate-focused bar can include: chocolate chip dough, chocolate filling, chocolate chip dough, and a chocolate chip topping (ABAC). A more nut-oriented dough bar includes: oatmeal chocolate chip base dough, chocolate filling, oatmeal chocolate chip dough, and chopped walnuts or other nuts (ABAC). Yet another bar includes chocolate chip dough, raspberry filling, chocolate chip dough, and combination morsels, e.g., chocolate and butterscotch (ABAC). A more child-friendly bar might include: chocolate dough, marshmallow or marshmallow cream filling, chocolate dough, and chopped nuts, e.g., pecans (ABAC). Two other exemplary dough arrangements include the following (each where the topping replaces the second dough layer): chocolate chip dough base with chocolate chip topping; or pecan shortbread dough base with chocolate chip topping.

In another embodiment, two or more doughs can be swirled together to produce a marbled effect in the block or in one of the layers or strips of the block. Preferably, however, the doughs are not swirled or blended but are separate layers that provide a clear visual distinction from each other. It is possible for a layer of dough or filling to be non-continuous or discrete, such as depicted in FIG. 5 described further below.

According to yet another embodiment of the invention that is not shown, the bakery dough block has at least two different vertical dough strips disposed on a base layer. The number of strips is not critical, but typically would be from 2 to 5. Preferably, the number of strips is four. If desired, these dough strips may be of different compositions. This can be done for example by adding to the basic dough different types of acceptable food grade flavors or colors. For example, it is possible to have a basic dough as first strip and a dough that contains cocoa as a second strip, using a chocolate dough as the base layer under the strips. The resultant bakery product would then have a clear or light portion and a dark portion once the internal separation zone was exposed. The way for producing multiple dough strips can be the same as for the layers, i.e., by extrusion, sheeting or other ways that are known in the art. Also, the strips can be placed in adjacent relation either horizontally or vertically in the dough block. Also, two or more dough strips can be swirled together to produce a marbled effect. Here also, the invention contemplates a wide range of dough stripes having different characteristics, composition, texture, taste, shapes and/or colors.

According to yet another embodiment of the invention, the block receives one or more decorations on its top face, also referred to herein as toppings. The decoration(s) can be either precisely placed or randomly put on the top of the block. The possible topping decorations are seeds, for example, sesame seeds, or chocolate, or nuts, or sugar, or spices, or powders or an icing, or sugar balls or other decorations. The decoration can be put on the top of the block either by a sprinkling device or by manual, robotic or mechanical means, all of which are known generally in the art.

According to yet another embodiment of the invention, the block of dough has a filling therein which filling is different from the basic dough. This filling could be either a creamy or a liquid filling, or is preferably a solid filling to provide the proper viscosity, such as a chocolate dough or another aromatized dough. In the case of a liquid filling, it has a viscosity sufficient to retain the filling adjacent the basic dough after baking so that it does not drip onto or into contact with the baking container. The filling can be provided in the dough in one or more streams. The number of streams as well as the amount of the filling is not critical: this filling can represent from about 5 to 50% by weight of the dough. The way of producing the block could be, e.g., by coextrusion, by injection, or by placing the filling in or on a first layer and then putting a second layer of dough on the filling and first layer to enclose the filling or other layer therein.

In one preferred embodiment, the dough bar includes a base layer of a first dough, a second layer of a second dough that is visually distinct and a different composition from the first dough, with a filling layer disposed therebetween and a topping material disposed over the second layer that is preferably formed of inclusions of <10,000 ct. size. The layers must remain intact after baking and each be clearly visible along an internal separation zone, e.g., a cross-section of the dough bar. The product is removed from its package, placed directly into an 8″×8″ baking container, and can be baked as noted herein. The dough bar has a net weight of about 16 to 18 ounces. Preferably, the dough bar is a square of about 5.5 inches to 7 inches on each side. These dough bars preferably do not contain pre-defined groove or score lines. The layers have at least 3 different textures, i.e., the topping, the dough, and the filling. The dough bar may have 4 different textures if the two dough layers are prepared with different compositions to provide a fourth texture. Preferably, the filling is sufficiently viscous that it does not ooze or flow off of the base layer even after the bar is cut or broken along a separation zone or while being baked.

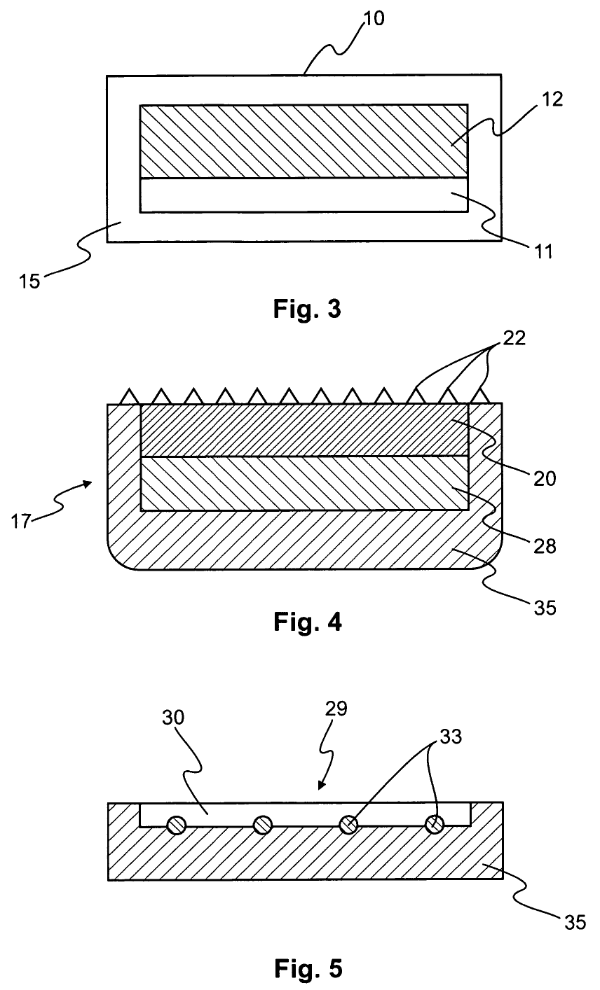

FIG. 3 illustrates a cross-sectional view of a dough bar 10 having a base layer 15, a second layer 11 disposed thereover, and a third layer 12 disposed over the base and second layers. Second layer 11 can be a different thickness than the other layers to provide a part of the visual distinction between layers. Second layer 11 can be a filling, while third layer 12 is a second dough that is at least visually distinct from the base layer 15. The base layer 15 extends upwards and entirely surrounds the filling layer 11 and second dough layer 12 in this depicted embodiment.

FIG. 4 illustrates a cross-section of a dough bar 17 according to the invention that has four adjacent vertical layers. Of course, it is also possible to have a different number of layers with different materials, as noted herein. As depicted, the base layer 35 is a first dough layer. The second layer 28 is a filling layer. The third layer is a second dough layer 20, and the dough bar is topped by a discontinuous fourth layer 22, which is a plurality of chips, such as chocolate, toffee, butterscotch, white chocolate, or the like, or a mixture thereof. As depicted, FIG. 4 has rounded bottom corners. It should be understood that any corners, either external (shown) or internal (not shown) within any dough bar of the invention, may be rounded or at right angles in different embodiments.

FIG. 5 shows a cross-section dough bar 29 that is filled with four streams 33 of filling material to provide a discontinuous layer of filling disposed over the base dough layer 35. The number of streams is not critical and any number can be used. For convenience, from one to six streams are advantageous in one embodiment. Instead of a filling, the streams can be made of a different dough or doughs. For example, the dough bar 29 can be a classical dough as before and streams 33 can be the same dough, but with cocoa. Another layer dough 30 is disposed over discontinuous layer 33.

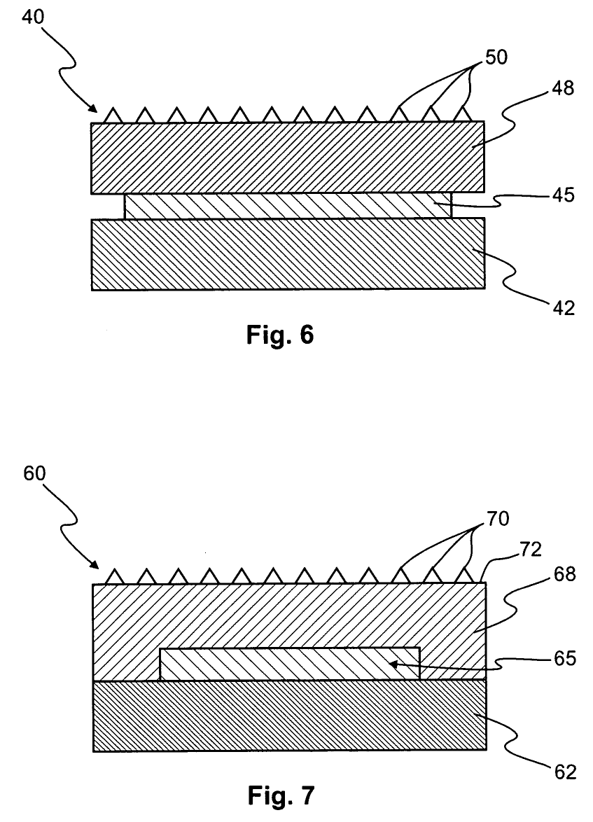

FIG. 6 shows a cross-sectional view of a dough bar 40 of the invention that has a continuous filling layer 45 between a base dough layer 42 and a second dough layer 48 with a surface decoration 50 disposed thereover. In one embodiment, which is depicted, the filling layer 45 is disposed over a portion of the base dough layer 42 to limit visibility of the layer before baking the dough bar and to minimize oozing of the filling layer 45 out of the dough bar 40 during or after baking.

FIG. 7 is a cross-sectional view of a dough bar 60 of the invention that has a continuous filling layer 65 (second dough layer) inside by being disposed over a base dough layer 62 and having a third dough layer 68 disposed thereabout. The third dough layer 68 is disposed not just over the filling layer 65, but is disposed around the edges of the filling layer 65 as well. The resulting dough bar 60 has only the base (first) and third dough layers forming a continuous outside surface of the dough bar 60, while the filling layer 65 is hidden within until a separation zone (not shown) is exposed. An optional but preferred fourth dough layer 70, which is preferably a surface decoration (i.e., a topping material), is disposed over a portion of the third dough layer 68. The topping 70 can be continuous (not shown), and in one preferred embodiment (not shown) the portion of the third dough layer 68 that it covers is the entire upper surface 72 of the third dough layer 68.

The filling material is not critical, the only condition being that it must be edible and capable of withstanding the baking process. Thus, for example, parchment paper is not used in the dough bar as a filling or between any layers, and preferably the dough bar is entirely free of parchment paper. Of course parchment paper could be used on an external surface to minimize sticking to the packaging if desired. The filling can be for example a fruit jam, or chocolate, or hazelnut or a mixture of chocolate and hazelnut or cream cheese, or coconut, or peanut butter. The ratio dough/filling is not critical, although this ratio is normally between about 40/60 and 98/2 when a filling is included. It should also be understood that fillings may form a continuous or discontinuous layer or layers above the base dough layer, and optionally but preferably between the base dough layer and another dough layer disposed above the filling.

The thicknesses of the various layers in the bakery dough bar may vary provided that the base dough layer is sufficiently thick to permit the dough bar to spread to contact the baking container and yet still not break or crack in a manner that would let other layers disposed thereover flow downwards or sideways to contact the baking container. When any filling or topping layers are included, these can be thin and as small as 0.01 to 1 cm. The filling or topping layer(s) are typically significantly thinner than any dough layers included in the same dough bar, e.g., about 20% to 80%, preferably about 25% to 50% of the thickness of the base dough layer.

In one embodiment, the dough bar is prepared and molded and/or partially cut using conventional devices to provide grooves, imprints, or score lines on the top of the bakery bar to facilitate separation of portions of the dough bar before baking. The grooves or score lines are typically made using marker rollers or any other apparatus known to those of ordinary-skill in the art, such as disclosed by U.S. Pat. No. 6,413,563 and its priority applications, which are incorporated herein by reference thereto. The number, size, depth, width, and type of groove or score lines may be selected based on various factors, e.g., desired portion size. Preferably, however, the dough bar of the present invention does not have portions separated pre-baking, because the bar is designed so it can be placed directly into a baking container without any manipulation. In this embodiment, there is no need for grooves, imprints, or score lines on the dough bar.

The dough bar may be provided with a topping either before or after any optional score lines are made. Typical toppings include sugar powder or granules, spices, non-pariels, nuts, chocolate or fruit pieces, materials that turn into a glaze during baking, flavoring agents, toffee, caramel, or the like, or a combination thereof.

The top surface of the dough bar may also be provided with raised or indented portions that create a shape or figure. If desired, different colors can be provided on the raised surfaces in a manner that is generally known in the dough processing art.

When fillings are provided in the dough, it is contemplated that non-dough fillings can be used. This would include ingredients, such as one or more sugars, chocolates, puddings, ice cream, soft candy formulations, peanut butter or other nut paste(s), chewing gum, caramel, cheesecake, white cream or paste, or a combination thereof. In one preferred embodiment, the filling includes caramel, cheesecake, white cream or paste, or a combination thereof. If desired, the filling can be provided between two dough layers. The filling can be continuous or placed in a discontinuous fashion before any optional additional dough layers are disposed thereon. It is also possible to remove part of the top dough layer or use a top dough layer with holes so that the filling is exposed. The holes of the top dough layer can also be provided with a desired shape or figure. Thus, a wide variety of different bakery product arrangements can be provided.

### EXAMPLES

The remainder of the description is made with reference to the examples, which illustrate preferred embodiments of the invention but are not intended to be limiting as to the scope of the invention.

### Example 1

### Brownie Dough for Use in a Bar According to the Invention

The various ingredients stated in Table I below are mixed, the proportions being in % by weight, to prepare a brownie mix.

TABLE I

| Component | Example 1 |
|---|---|
| Sugar | 42 |
| Egg Powder | 4 |
| Emulsifier | 0.25 |
| Baking Powder | 0.5 |
| Shortening | 16.75 |
| Cocoa | 6 |
| Starch/Flour | 11 |
| Flavoring and flavor enhancer | 1.0 |
| Water | 12.5 |
| Chocolate pieces | 6 |

The dough thus prepared is stored for as long as 6 months in the refrigerator. The block of dough size of about 11×16 cm is placed in a greased 20×20 cm baking tin for baking. The formulation of the dough enables the brownie to fill the pan properly to facilitate baking and result in a leavened appearance to the baked product. The block is baked for about 40 minutes at 175° C.

### Example 2

### Brownie Dough Bar Prepared According to the Invention

The various ingredients stated in Table II below are mixed for making a ready-for-use brownie dough having two layers. The amounts are in weight %.

TABLE II

| Example | Light dough | Dark dough |
|---|---|---|
| Sugar | 50 | 44.6 |
| Egg white | 7.5 | 7.5 |
| Whole egg | 7.5 | 7.5 |
| Emulsifier | 0.25 | 0.25 |
| Baking powder | 0.5 | 0.5 |
| Flavoring and flavor enhancer | 0.6 | 0.6 |
| Fat | 15.75 | 15.75 |
| Water | 10.8 | 10.8 |
| Gellan Gum | 0.1 | 0.1 |
| Starch/mod | 2 | 2 |
| Flour | 5 | 5 |
| Cocoa | — | 5.4 |

This two-layer dough is made by sheeting or extrusion and the dough is stored up to 6 months in the refrigerator. The block baked in an appropriately sized baking tin or pan for 10 to 40 minutes at 175° C. to form baked brownie that includes different color layers. The concentration of sugar and flour can be adjusted to achieve the desired workability: the concentration of sugar is increased and that of flour is decreased.

### Example 3

### Cake Dough Bar According to the Invention

This is an example for a small cake bar that has a filling. The basic dough is the dough of the preceding Example 2 (the light dough). The filling is an apricot jam with a dough/jam ratio of 70/30. This small cake is produced by coextrusion or another suitable technique. As before, the dough is stored in the refrigerator and then baked as in Example 2. During the baking, the dough opens and the jam flows on the top of the cake bar.

In each example, the resultant baked cake was found to be cooked quite uniformly. From the preceding it can be seen that a wide variety of dough products can be made according to this invention. In the most preferred embodiment, the dough is a brownie dough formulation that can easily be made into fresh brownies in a short time without any significant effort on the part of the consumer beyond opening the package, placing the bar in a baking container, turning on the oven and timing the product placed therein to bake, and then separating one or more portions of the dough bar after baking to expose the visually distinct layers, which are not visible before separation in a preferred embodiment.

### Example 4

### A Dough Bar Structure According to the Invention

A dough bar can be prepared as follows having a 6.25″×6.25″ size:

| | | | % of |
|---|---|---|---|
| Layer (top to bottom) | Weight (oz) | Weight (g) | Product (g) |
| 4 (topping) | 1 | 28.35 | 5.6 |
| 3 (second dough) | 7 | 198.3 | 38.9 |
| 2 (filling) | 3 | 85.05 | 16.7 |
| 1 (first dough) | 7 | 198.3 | 38.9 |
| Total: | 18 | 510 | 100 |

Although preferred embodiments of the invention have been described in the foregoing description, it will be understood that the invention is not limited to the specific embodiments disclosed herein but is capable of numerous modifications by those of ordinary skill in the art. It will be understood that the materials used and the chemical details may be slightly different or modified from the descriptions herein without departing from the methods and compositions disclosed and taught by the present invention.

What is claimed is:

1. A ready-to-bake dough bar having edges, a top, and a bottom in a pre-defined shape which comprises:
a first dough portion having a first texture and that forms a base layer, wherein the first dough is sufficiently viscous to retain its pre-defined shape under ambient temperature before baking while being transferred from a sealed storage package to a baking container having a shape, yet is sufficiently fluid to flow at baking temperatures to conform to the shape of the baking container; and
a second dough portion having a second, different texture that forms a second layer disposed over a portion of the base layer and that is retained on the first dough portion during and after baking to minimize or avoid burning or scorching of the second dough portion, wherein the dough portions are associated with each other for simultaneous baking and together form a parallelepiped-shaped bar that is the ready-to-bake dough bar, and wherein the second dough portion is hidden from view along the bar edges until an internal portion of the ready-to-bake dough bar is separated from the remainder of the bar along a separation zone oriented from the top to the bottom of the bar.

2. The ready-to-bake dough bar of claim 1, further comprising a third dough portion disposed over and around a portion of the second layer so that the first, second, and third dough portions together form the ready-to-bake bar.

3. The ready-to-bake dough bar of claim 2, wherein the third dough portion entirely surrounds the second dough portion and the first and third dough portions form the entire outer surface of the dough bar.

4. The ready-to-bake dough bar of claim 3, further comprising at least one dough layer disposed over a portion of the third layer so as to further form an upper layer of the dough bar.

5. The ready-to-bake dough bar of claim 2, wherein the third dough portion has a third texture that is different from the second texture of the second dough portion.

6. The ready-to-bake dough bar of claim 1, further comprising a plurality of dough portions disposed over a portion of the base layer, over a portion of the second layer, or both so that the first, second, and plurality of dough portions together form the ready-to-bake bar.

7. The ready-to-bake dough bar of claim 1, wherein the first and second dough portions each have a different flavor and color.

8. The ready-to-bake dough bar of claim 1, wherein the first and second dough portions are sufficiently viscous to inhibit or avoid miscibility thereof even at about 185° F.

9. The ready-to-bake dough bar of claim 4, wherein the second layer comprises a filling and the fourth layer comprises a discontinuous topping disposed over a portion of the third dough portion.

10. A ready-to-bake dough bar product that is formed from the ready-to-bake dough bar of claim 1, a substrate that supports the dough bar during shipping to minimize modification of its shape, and an enclosure that contains, protects, and seals the dough bar therein until it is opened.

11. A separated baked dough bar which comprises a separated portion of the baked ready-to-bake dough bar of claim 1 having at least two visually distinct layers visible at the separation zone.

12. A method of providing a dough product having a top, a bottom, and edges, that comprises:
providing at least first and second dough portions that are formulated to differ in texture and appearance after the dough product is baked;
associating the dough portions together with the first dough forming a base layer and the second dough disposed over a portion of the base layer to form a ready-to-bake parallelepiped-shaped dough product so that the second dough portion is hidden from view along the bar edges;
transporting the dough product to a remote location in a sealed package; and
providing instructions which comprise:
removing the ready-to-bake dough product from the package;
directly placing the product in a baking container without modifying its shape; and
baking the ready-to-bake dough product.

13. The method of claim 12, wherein the dough product obtained after baking has at least two portions that become visible when a portion of the dough product is separated from a second portion of the dough product along a top to bottom interface, wherein the at least two portions each has a different texture and a different appearance.

14. A method for making a fresh baked dough bar product which comprises:
formulating a first dough that is sufficiently fluid to flow yet sufficiently viscous to retain a second dough at a baking temperature;
formulating the second dough and disposing it over a portion of the first dough so as to be retained thereby; and
providing the doughs in the form of a bar having at least two layers to form a multi-layer structure in a sealed package, the bar having sufficient firmness to be handled without breaking or being altered in overall shape when transferred from the package to a baking container,
wherein when fresh baked dough bars are desired, a consumer removes the dough bar from the package, places it in the baking container and places the container and bar into an oven heated to the baking temperature for a sufficient time to prepare a baked dough bar product that is not collapsed in the center of the container after baking, and
wherein, when one or more portions of the baked dough bars are separated along a top to a bottom interface from the remainder, the multi-layer structure of the bar becomes visible to the consumer.

15. The method of claim 14 which further comprises formulating the dough in a parallelepiped shape having a thickness of about 1 cm to 5 cm prior to baking.

16. The method of claim 15 wherein the dough bar is configured in the shape of a rectangular bar having a length of about 8 cm to 20 cm and a width of about 8 cm to 20 cm and the package comprises a plastic material.

17. The method of claim 14 wherein the consumer is directed to prepare the product by removing the dough bar from the sealed package and placing it in the baking container, the container and the dough bar then being placed in an oven that is heated to a temperature of about 160° C. to 185° C. for a time of about 10 minutes to 75 minutes to prepare the baked dough bar product, and separating smaller portions of the dough bar from the remainder for serving.

18. The method of claim 14, wherein the dough bar comprises a brownie bar or a cookie bar.

19. The method of claim 14, wherein the baking container is sized and dimensioned to provide a margin of about 1 cm to 6 cm between each side wall of the container and the edges of the dough bar, and wherein the dough on each edge flows to a position adjacent the margin of, or contacting, the container during baking.
